(19) United States
(12) Patent Application Publication
(10) Pub. No.: US 2011/0259278 A1
(43) Pub. Date: Oct. 27, 2011

(54) MOVABLE KENNEL

(76) Inventor: Victor Collingham, Eddy, TX (US)

(21) Appl. No.: 13/178,493

(22) Filed: Jul. 8, 2011

Related U.S. Application Data
(62) Division of application No. 12/250,663, filed on Oct. 14, 2008.

(51) Int. Cl. A01K 1/02; F16C 13/00

(52) U.S. Cl. 119/496; 492/15

(57) ABSTRACT

A mobile pet kennel comprising: a plurality of kennel walls connected to form an enclosure; rollers; and a roller positioner, wherein the roller positioner is configured to retain the rollers in a selectable first or second position relative to the kennel walls. In the first position the rollers contact the ground and in the second position the rollers are elevated above the ground.

### TECHNICAL FIELD OF THE INVENTION

The present invention is generally directed to outdoor animal kennels.

### BACKGROUND ART OF THE INVENTION

Kennels for outdoor animals, such as pet dogs, are typically large enclosures constructed with materials similar to a chain link fence. The enclosures are preferably large enough to give a dog room to run around within the kennel. As a result, the kennels are heavy and bulky. In many situations, it would be advantageous to be able to move the kennel—either temporarily, such as for mowing a yard, or permanently to a new location. Prior art kennels are very difficult to move, often requiring disassembly or a large number of persons. What is needed is an outdoor dog kennel that may be easily moved when desired, yet remains stable and stationary at other times.

### SUMMARY

The present invention solves problems with the prior art by providing rollers, attached to a kennel, and configurable in first and second positions. In the first position, the rollers contact the ground and the kennel walls are elevated above the ground. In the second position, the kennel walls rest on the ground while the rollers are elevated. In one embodiment, a kit provides rollers which are attachable to existing kennels. The kit allows rollers to be easily attached to each corner of the kennel. The rollers remain attached and are movable from a mobile position, with wheels in contact with the ground, to a stationary position with wheels off the ground. In another embodiment, the kit includes two or more brackets which secure a shaft to the kennel. A device, such as a cotter pin, secures the shaft in two or more selectable positions relative to the brackets. The wheels are lowered by 1) lifting a portion of the kennel, 2) removing a cotter pin from a first position, 3) lowering the wheel, and 4) inserting the cotter pin in a second position. The kit may also include a handle for easily lifting the kennel.

### BRIEF DESCRIPTION OF THE DRAWINGS

For a more complete understanding of the present invention and for further advantages thereof, reference is now made to the following Description of the Preferred Embodiments taken in conjunction with the accompanying Drawings in which:

FIG. 1 is a perspective view of a typical outdoor kennel.

FIG. 2A is a perspective view of a mobile kennel with wheels in a raised position.

FIG. 2B is a perspective view of a mobile kennel with wheels in a lowered position.

FIG. 3A is a closer view of a roller assembly for a mobile kennel, with wheel in a raised position.

FIG. 3B is a closer view of a roller assembly for a mobile kennel, with wheel in a lowered position.

FIG. 4 is a closer view of a mounting bracket for a mobile kennel.

FIG. 5 is a closer view of a portion of a roller shaft for a mobile kennel.

FIG. 6A is a closer view of a shaft engaged in a mounting bracket in a raised position.

FIG. 6B is a closer view of a shaft engaged in a mounting bracket in a lowered position.

FIG. 7 shows a handle for a dog kennel.

### DETAILED DESCRIPTION OF THE PREFERRED EMBODIMENTS

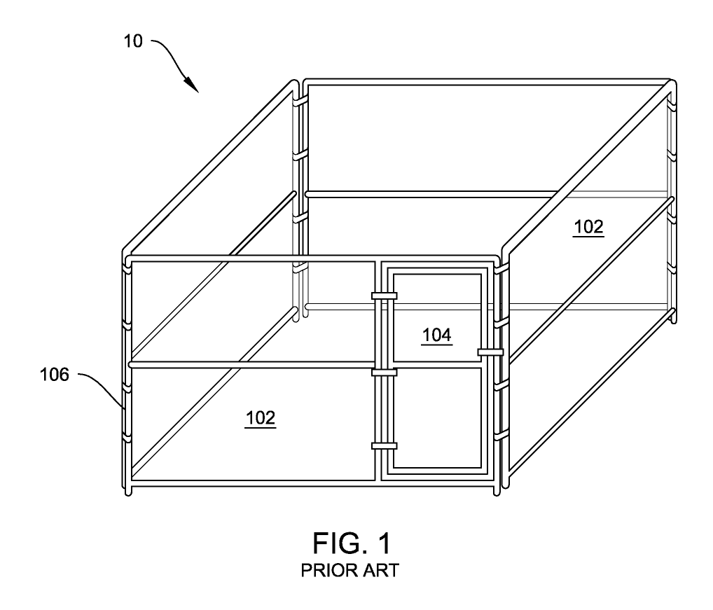

FIG. 1 shows a kennel 10 for a large dog. Kennel 10 shown in FIG. 1 comprises four walls 102. One of the walls 102 comprises a door 104. Walls 102 and door 104 are preferably constructed of a galvanized steel frame supporting a chain-link mesh (not shown). Walls 102 are connected at corner poles 106 to form a square enclosure. Kennel 10 does not include a floor or roof.

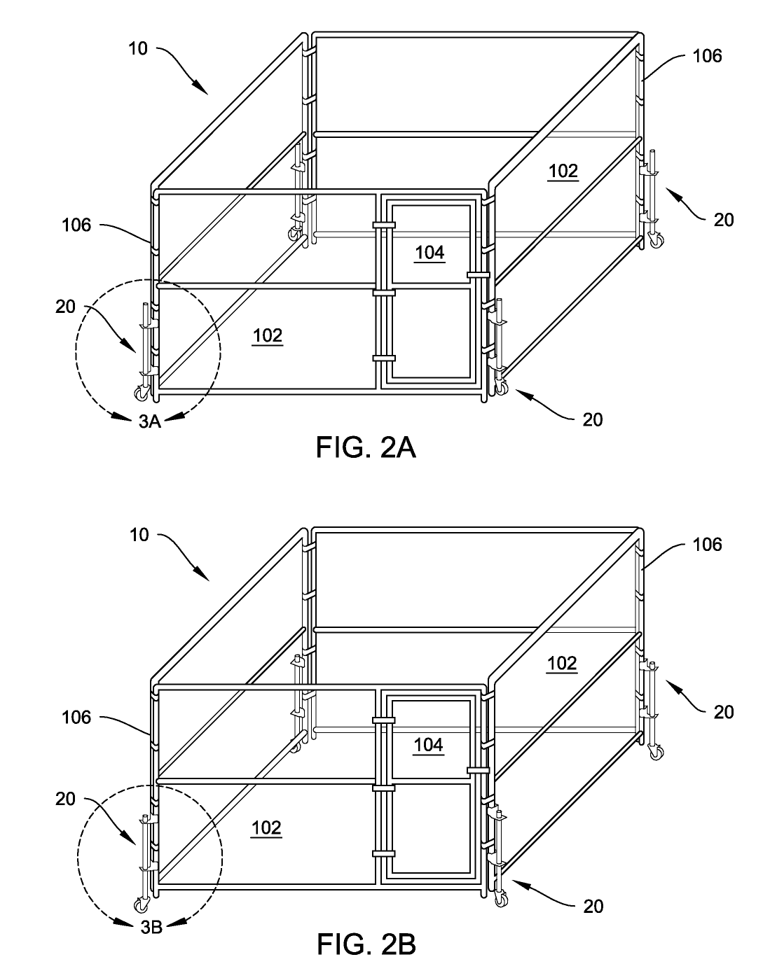

FIGS. 2A and 2B show a kennel embodying features of the present invention. A roller assembly 20 is preferably connected to a corner pole 106 at each corner of kennel 10. In FIG. 2A roller assembly 20 is shown with rollers in a raised position. In this position, walls 102 rest on the ground. In FIG. 2B roller assembly 20 is shown with rollers in a lowered position. In this position, walls 102 are elevated above the ground.

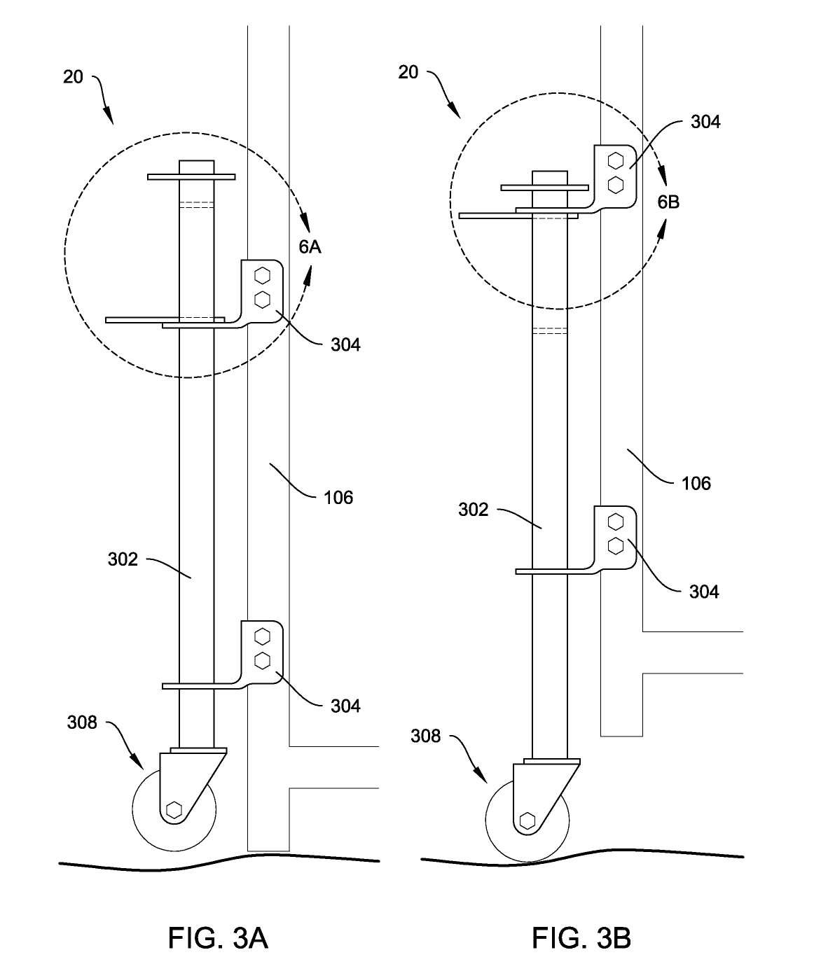

FIG. 3A shows a closer view of roller assembly 20. Roller assembly 20 includes a shaft 302 which is attached to corner poles 106 by brackets 304. Shaft 302 is preferably 13 gauge tube constructed from powder coated cold-rolled steel with an outer diameter of about 11/16″ and in inner diameter of about 0.520″. A roller 308 is attached to the bottom of shaft 302. Roller 308 is preferably a swivel caster with a steel body and rubber wheels about 4″ in diameter, however, many other rollers, including many types of wheels, are known and may be used. Roller 308 preferably comprises a 1 1/4″ long steel prong (not shown) with an outer diameter of about 7/16″ and a ring clip (not shown). Roller 308 is preferably held in shaft 302 by the ring clip and a nylon bushing (not shown) with an inner diameter of 7/16″ and an outer diameter of ½″. Other dimensions for the steel prong, nylon bushing, and shaft 302 may be used, however, the listed dimensions have been found to securely attach roller 308 to shaft 302 without the need for gluing. Alternatively, roller 302 may be attached to shaft 308 by gluing, welding, or other methods.

Roller assembly 20 preferably comprises at least two brackets 304 which are attached to higher and lower positions on corner pole 106, such as at about 10″ and 30″ from the bottom of corner pole 106. Using multiple brackets 304 is helpful to keep shaft 302 aligned with corner pole 106. Alternatively, shaft 302 could be maintained in alignment with corner pole 106 by other means, such as providing a tube (not shown) attached to bracket 304 and positioning shaft 302 within the tube. In FIG. 3A, roller assembly 20 is shown with roller 308 in the raised position. FIG. 3B shows roller assembly 20 with roller 308 in the lowered position.

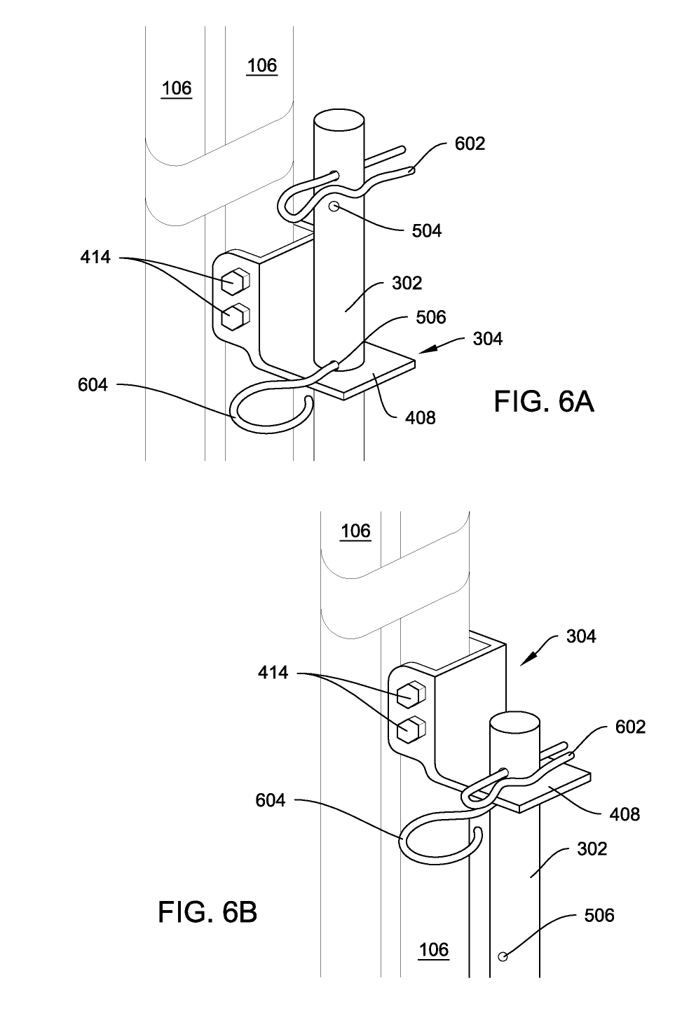

FIG. 4 is a closer view of bracket 304. Bracket 304 comprises two mounting panels 404, a front panel 406, and a positioning panel 408. Mounting panels 404, front panel 406, and positioning panels 408 are preferably constructed from a single piece of metal, preferably powder coated steel. Mounting holes 412 are defined in each mounting panel 404. Bracket 304 is preferably mounted to corner pole 106 by positioning corner pole 106 between the two mounting panels 404 and securing bracket 304 in place using screws 414 (seen in FIGS. 6A and 6B) through mounting holes 412 and corner pole 106. Screws 414 are preferably self tapping screws, however, bolts or other types of screws may be used. To facilitate securing bracket 304 to corner pole 106, bracket holes (not shown) are preferably pre-drilled in corner pole 106. A positioning hole 402 is defined in positioning panel 408. In operation, shaft 302 is retained in positioning hole 402 but is able to slide up and down within positioning hole 402. As discussed above, alternatively to positioning hole 402, bracket 304 may comprise an outer tube (not shown) configured to align and retain shaft 302 with the ability to slide within the tube.

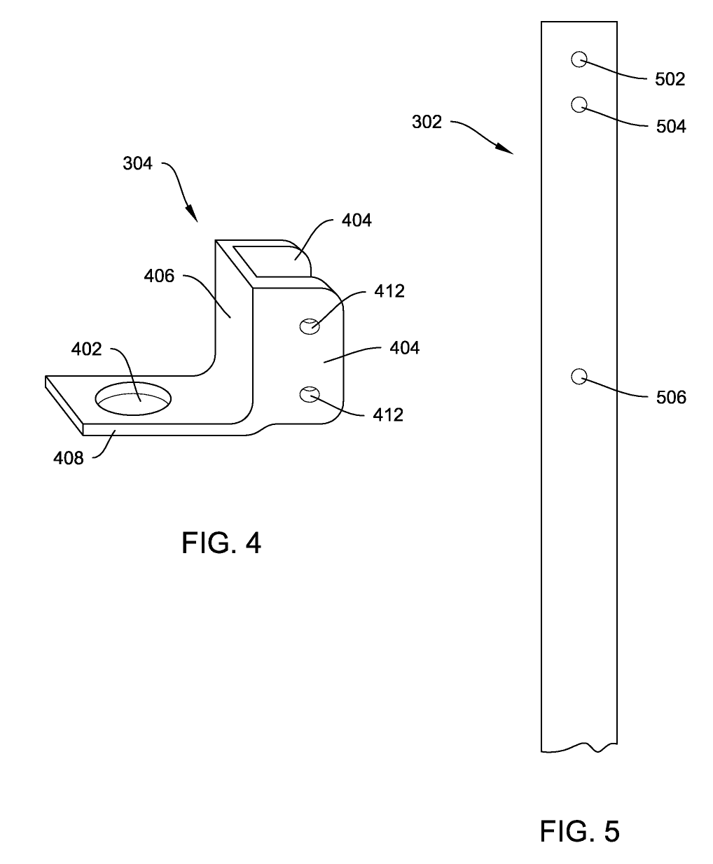

FIG. 5 is a view of an upper section of shaft 302. Preferably, three sets of holes are defined in shaft 302: upper retaining holes 502, support holes 504, and lower retaining holes 506. Each set of holes comprises a pair of holes defined at equal heights on opposite sides of shaft 302. Upper retaining holes 502 are preferably defined near an upper end of shaft 302. Support holes 504 are defined slightly below upper retaining holes. Lower retaining holes 506 are preferably defined several inches below support holes 504. Lower retaining holes 506 are configured so that, when shaft 302 is in positioning hole 402 and a support pin 604 (shown in FIGS. 6A and 6B) is placed in lower retaining holes 506, shaft 302 is held in an elevated position with rollers 308 above the ground. Support holes 504 are configured so that, when shaft 302 is in positioning hole 402 and support pin 604 (shown in FIGS. 6A and 6B) is placed through support holes 504, support pin 604 will support walls 102 of kennel 10 above the ground on rollers 308. In one embodiment, upper retaining holes 502, support holes 504, and lower retaining holes 506 are about ⅝″, 1″ and 7″, respectively, below the top of shaft 302 and are about 3/16″ in diameter. Support pin 604 and retaining pin 602 are preferably steel.

Upper retaining holes 502 are configured so that when retaining pin 602 (shown in FIGS. 6A and 6B) is place through the retaining holes 502, shaft 302 going through positioning hole 402 will not disengage with bracket 304. This configuration helps prevent accidental disassembly. Other configurations, such as an enlarged upper cap (not shown) which does not fit through positioning hole 402 would provide similar benefit. As described above, the upper retaining holes 502, support holes 504 and lower retaining holes 506 are preferably configured to interact with an upper bracket 304. Where multiple brackets 304 are used, the holes may be configured to interact with any of the brackets 304, however, using the topmost bracket 304 will generally be more convenient to the user. Shaft 302 is preferably provided with an end cap (not shown) configured to protect the interior of shaft 302 from the elements and from entry of foreign objects. The end cap is preferably plastic.

FIGS. 6A and 6B show a closer view of a bracket 304 engaging a shaft 302. In FIG. 6A, shaft 302 is shown in a raised position, in which walls 102 will contact the ground and rollers 308 will be elevated. A retaining pin 602 placed through lower retaining holes 506 supports the weight of shaft 302 and rollers 308 in an elevated position off the ground. In FIG. 6B, shaft 302 is show in its lower position. In this position, support pin 604 is placed through support holes 504 defined in shaft 302. Positioning panel 408 rests on support pin 604 and a portion of the weight of kennel 10 is transferred to shaft 302 through support pin 604. Retaining pin 602 is positioned in upper retaining holes 502. Alternatively to using pins extending completely through shaft 302, a shorter pin (not shown) could potentially be used and held in position by, for example, being attached to bracket 304 and biased toward shaft 302 by a spring (not shown) or similar device. Further alternatively, shaft 302 could be positioned using a clamp or other friction means.

To transform kennel 10 from its stationary position (with walls 102 resting on the ground and rollers 308 elevated), to its mobile position (with walls 102 elevated and rollers 308 on the ground) the user lifts a portion of kennel 10, preferably near a corner pole 106. While lifting kennel 10, the user removes support pin 604 from lower retaining holes 506 and allows shaft 302 to slide down until retaining pin 602 contacts positioning panel 408. The user then inserts support pin 604 into support holes 504 and lowers kennel 10 until positioning panel 408 rests on support pin 604. To transform kennel from its mobile position to its stationary position, the user lifts kennel 10, removes support pin 604, and lowers kennel 10 until walls 102 rest on the ground. The user then lifts shaft 302 until lower retaining holes 506 are above positioning panel 408. Next the user places support pin 604 through lower retaining holes 506 and releases shaft 302.

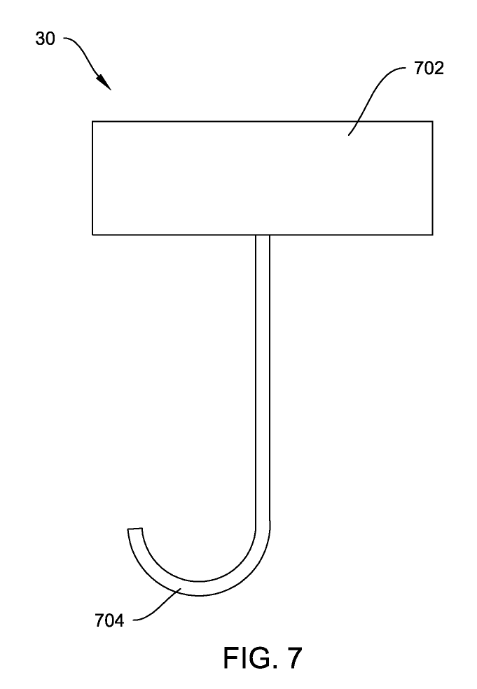

Because it can be painful to lift kennel 10 using only the chain link, a lifter 30 may be provided as shown in FIG. 7. Lifter 30 preferably comprises a wooden handle 702 attached to a metal engaging hook 704. The user may lift kennel 10 using handle 702 by engaging hook 704 with the chain link. Many other handles designs are know and may be used.

Although the invention has been described with reference to specific embodiments, this description is not meant to be construed in a limiting sense. Various modifications of the disclosed embodiments, as well as alternative embodiments of the inventions, will be apparent to persons skilled in the art upon reference to the description of the invention. It is, therefore, contemplated that the appended claims will cover such modifications that fall within the scope of the invention.

I claim:

1. A mobile pet kennel comprising:
A plurality of kennel walls, wherein the kennel walls are connected to form an enclosure;
a roller; and
a roller positioner, wherein the roller positioner is configured to retain the roller in a selectable first or second position relative to the kennel walls, wherein in the first position the roller contacts the ground and in the second position the roller is elevated above the ground.

2. The mobile pet kennel of claim 1 wherein the roller positioner comprises:
a bracket attached to a kennel wall;
a bracket hole defined in the bracket;
a shaft positioned within the bracket hole;
a roller attached to the shaft; and
a shaft positioner configured to retain the shaft in a first or second position relative to the bracket.

3. The mobile pet kennel of claim 2 wherein a positioning hole is defined in the shaft and wherein shaft positioner comprises a pin configured to engage the positioning hole.

4. The mobile pet kennel of claim 2 wherein the shaft positioner comprises a clamp.

5. The mobile pet kennel of claim 1 wherein the roller is a wheel.

6. The mobile pet kennel of claim 1 wherein the roller is a swivel caster.

7. A roller kit for a pet kennel comprising:
a bracket attachable to a kennel wall;
a bracket hole defined in the bracket;
a shaft positioned in the bracket hole;
a roller attached to the shaft; and
a shaft positioner configured to retain the shaft in a first or second position relative to the bracket, wherein in the first position the roller contacts the ground and in the second position the roller is elevated above the ground;

8. The mobile pet kennel of claim 7 wherein a positioning hole is defined in the shaft and wherein shaft positioner comprises a pin configured to engage the positioning hole.

9. The mobile pet kennel of claim 7 wherein the shaft positioner comprises a clamp.

10. The mobile pet kennel of claim 7 wherein the roller is a wheel.

11. The mobile pet kennel of claim 7 wherein the roller is a swivel caster.
